(19) United States
(12) Patent Application Publication
(10) Pub. No.: US 2026/0142877 A1
(43) Pub. Date: May 21, 2026

(54) METHODS, ARCHITECTURES, APPARATUSES AND SYSTEMS FOR SENSING DEVICE RECONFIGURATION

(71) Applicant: InterDigital Patent Holdings, Inc., Wilmington, DE (US)

(72) Inventors: Carlos Jesus Bernardos, Madrid (ES); Alain Mourad, Ascot (GB); Magurawalage Chathura Madhusanka Sarathchandra, London (GB); Sebastian Robitzsch, London (GB)

(21) Appl. No.: 18/949,492

(22) Filed: Nov. 15, 2024

(51) Int. Cl. H04L 41/0816

(52) U.S. Cl. CPC H04L 41/0816

(57) ABSTRACT

A wireless transmit/receive unit (WTRU) in communication with a wireless network may be configured for sensing a target object based on a first configuration. The WTRU may detect an occurrence of an event which comprises at least one of: movement of the WTRU, movement of the target object, or a change in the sensing capability of the WTRU. The WTRU transmits to the wireless network a first information based on the detecting. The WTRU may then receive second information indicative of a second configuration. The second configuration may be based on the first information. In response to the WTRU receiving the second information, the WTRU is configured for sensing the target object based on the second configuration. The WTRU then performs sensing operations based on the second configuration to generate sensing information.

### TECHNICAL FIELD

The present disclosure is generally directed to the fields of communications, software and encoding, including, for example, to methods, architectures, apparatuses, systems related to sensor reconfiguration, including but not limited to sensor reconfiguration during distributed integrated sensing and communication tasks.

### SUMMARY

In accordance with certain embodiments of the present disclosure, methods and systems are provided for operating a WTRU in communication with a wireless network. The WTRU may be configured for sensing a target object based on a first configuration. In certain embodiments, the first configuration is based on a distributed sensing task involving the WTRU and at least one other device. The WTRU may detect an occurrence of an event, where the event includes at least one of: movement of the WTRU, movement of the target object, or a change in the sensing capability of the WTRU. The WTRU may transmit, to the wireless network, first information based on the detecting. In certain embodiments, detecting the occurrence of an event may include forecasting that an event will occur, and the first information may include an indication of when the forecasted event will occur. The WTRU may receive, from the wireless network, second information indicative of a second configuration. The second configuration may be based on the first information. In certain embodiments, the second configuration (e.g., the reconfiguration) may be based on at least one of: sensor data markings, fusion information related to the sensing of the target object, a type of sensor fusion to be performed, an indication of processing needed to process the sensing information, a node of the wireless network that performs sensor fusion, or a synchronization requirement. In response to the WTRU receiving the second information, the WTRU may be configured for sensing the target object based on the second configuration. The WTRU may perform sensing operations based on the second configuration to generate sensing information.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system according to some embodiments of this disclosure;

FIG. 1B is a system diagram illustrating an example wireless transmit/receive unit (WTRU) that may be used within the communications system illustrated in FIG. 1A according to some embodiments of this disclosure;

FIG. 1C is a system diagram illustrating an example radio access network (RAN) and an example core network (CN) that may be used within the communications system illustrated in FIG. 1A according to some embodiments of this disclosure;

FIG. 1D is a system diagram illustrating a further example RAN and a further example CN that may be used within the communications system illustrated in FIG. 1A according to some embodiments of this disclosure;

FIG. 1E is a block diagram illustrating an example of an integrated sensing function (ISF) that may be executed on processing equipment coupled to communication equipment and that may be used within the communications system illustrated in FIG. 1A according to some embodiments of this disclosure;

FIG. 2 shows an illustrative reference model of a wireless network with which a UE communicates, according to one or more embodiments of this disclosure;

FIG. 3 illustrates an example of a pedestrian and/or animal intrusion detection according to one or more embodiments of this disclosure;

FIG. 4 illustrates an example of intruder detection in surroundings of a smart home according to one or more embodiments of this disclosure;

FIG. 5A illustrates an example of multiple access channel with mono-static base station sensing according to one or more embodiments of this disclosure;

FIG. 5B illustrates an example of a multiple access channel with bi-static base station sensing according to one or more embodiments of this disclosure;

FIG. 6A illustrates an example of mobile complementary fusion with fusion at the RAN node in a monostatic scenario according to one or more embodiments of this disclosure;

FIG. 6B illustrates an example of mobile complementary fusion with a fuser user equipment in a bi-static scenario according to one or more embodiments of this disclosure;

FIG. 7 shows a diagram that illustrates a dynamic sensor group reconfiguration triggered by mobility of an object according to one or more embodiments of this disclosure;

FIG. 8 shows a sequence diagram of an illustrative sequence involved with reconfiguring a distributed sensing task according to one or more embodiments of this disclosure; and

FIG. 9 is a flowchart of illustrative steps for sensor reconfiguring according to one or more embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

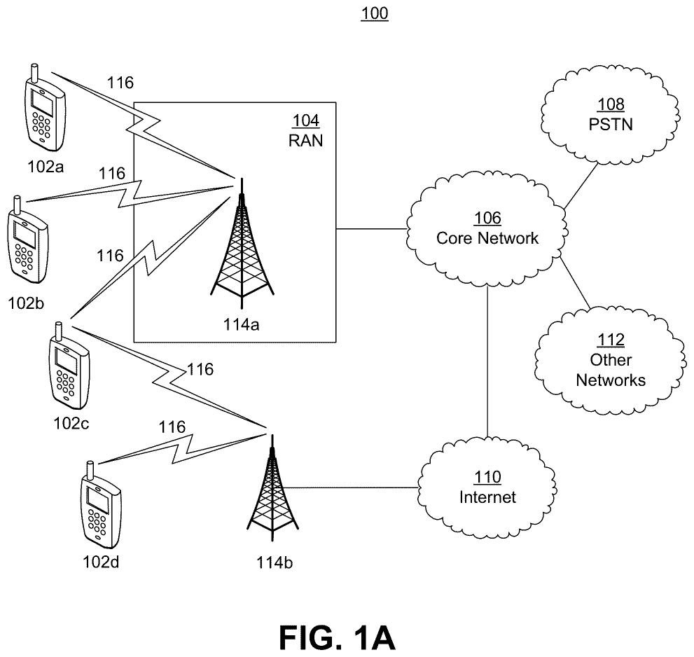

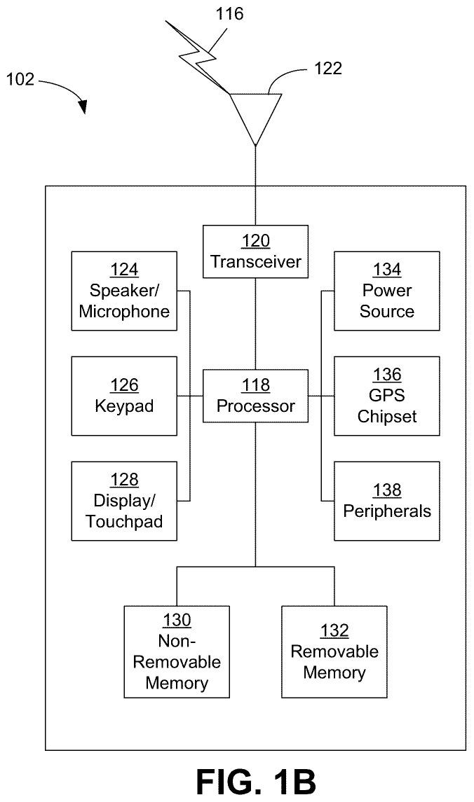

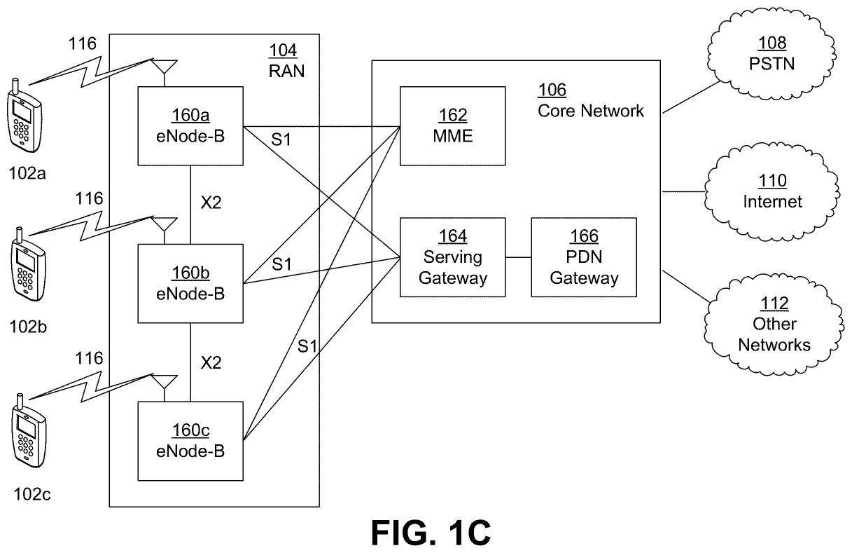

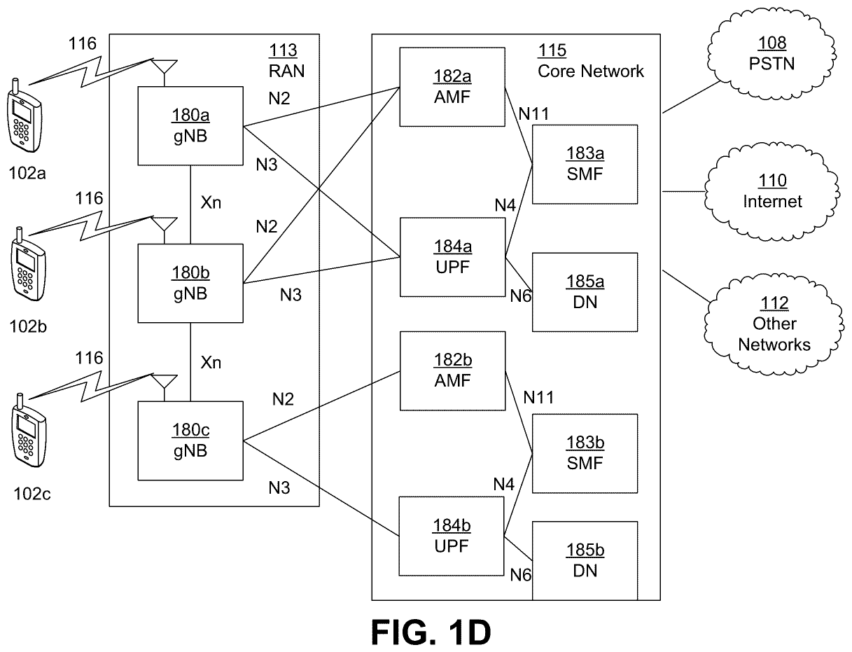

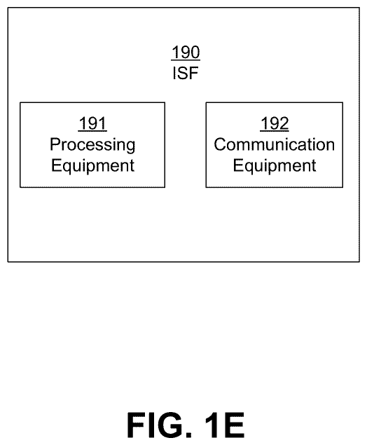

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) one or more user equipment (UE) components, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE, and vice versa, e.g., if the WTRU includes only one active UE.

As used herein, a sensing device may refer to any device that can perform sensing based on a wireless signal, including but not limited to any of the WTRUs 102a, 102b, 102c and 102d, any UE, any base station (e.g., base station 114a of RAN 104, or base station 114b), any suitable eNode-B (e.g., any eNode-B 160a, 160b, or 160c), any suitable gNode-B (e.g., any gNode-B 180a, 180b, or 180c), any hardware of a core network (e.g., hardware configured to execute any access and mobility function (AMF), user plane function (UPF), session management function (SMF) or data network (DN) of a core network), or any other suitable device. In this disclosure, a sensing device may be interchangeably referred to as a sensor, a sensor node, or a sensing node.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b need not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment. It will be appreciated that the WTRU 102 may include multiple iterations of any the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

As mentioned, although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and/or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, and 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode need not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, and 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180 c while also communicating with/connecting to another RAN such as eNode-Bs 160a, 160b, and 160c. For example, WTRUs 102a, 102b, 102c may implement DC principles to communicate with one or more gNBs 180a, 180b, 180c and one or more eNode-Bs 160a, 160b, and 160c substantially simultaneously. In the non-standalone configuration, eNode-Bs 160a, 160b, and 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards UPFs 184a, 184b, routing of control plane information towards AMFs 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one SMF 183a, 183b, and at least one DN 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The MME 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

FIG. 1E is a block diagram illustrating an example of an ISF that may be executed on processing equipment coupled to communication equipment and that may be used within the communications system illustrated in FIG. 1A according to some embodiments of this disclosure. The ISF 190 of FIG. 1E can be part of RAN 104 or 113, a part of core network 106 or 115, a part of other networks 112, or any other suitable part (e.g., node) of a wireless network. The ISF 190 can be any suitable hardware, software, or both, for implementing the functionality of the ISF 190 as described in the present disclosure. As shown, ISF 190 may include processing equipment 191 to execute the logic of ISF 190 as described in the present disclosure. For example, processing equipment 191 may determine how to reconfigure sensing devices for performing an ongoing sensing task. Communication equipment 192 may be included among the hardware that executes ISF 190 to send and receive data between ISF 190 and any other suitable sensing device (e.g., between ISF 190 and one or more of WTRUs 102a, 102b, 102c, or 102d, RAN 104, core network 106, any suitable UE, any suitable base station 114, any suitable fusion device, any other device executing a function of a wireless network, or any combination thereof). It will be understood that ISF 190 may include one or more physical hardware components that may be distributed. For example, if the ISF 190 is implemented at any one or more of the NEF, AMF, SMF, or RAN, then the hardware of ISF 190 would be the same as the hardware of the one or more of the NEF, AMF, SMF, or RAN. It will also be understood that the ISF 190 is one illustrative and non-limiting function that may be used to perform a distributed sensing task with sensing device reconfiguration.

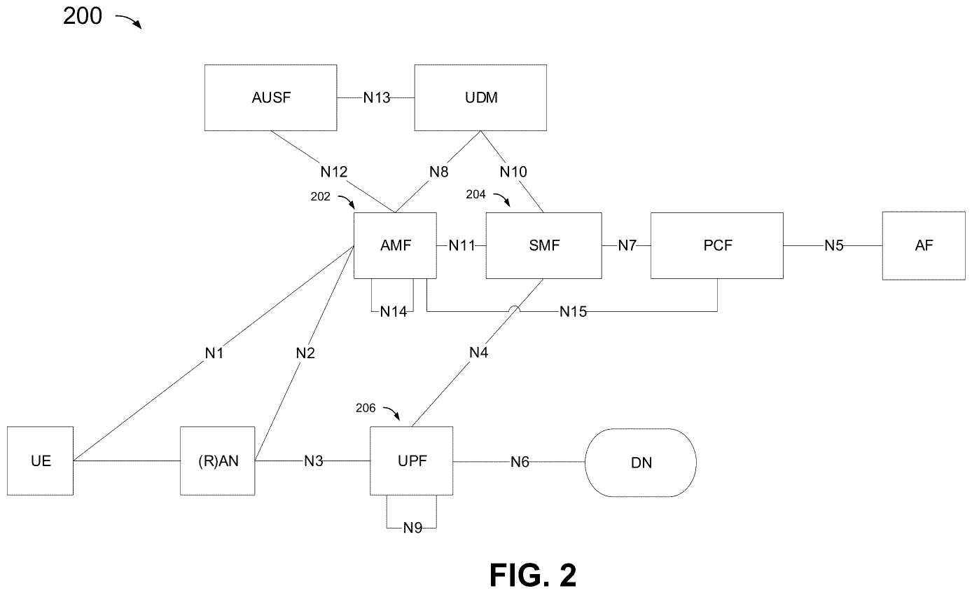

In accordance with some embodiments of this disclosure, the devices and systems of FIGS. 1A-1D may be used in connection with devices, systems, and methods for sensor reconfiguration. For example, in some embodiments of this disclosure, the devices and systems of FIGS. 1A-1D may be used in connection with the devices, systems, and methods described in FIGS. 2-9.

In accordance with some embodiments of this disclosure, a reference model of a 5G network, or other suitable network, is shown in FIG. 2 and described as follows. FIG. 2 illustrates an example of a reference model of a network architecture (e.g., a 5G or NextGen network). In certain embodiments, the AMF 202 (e.g., which may be the same as AMF 182a or 182b) includes the functionalities of registration management, connection management, reachability management, and mobility management. In certain representative embodiments, the SMF 204 (e.g., which may be the same as SMF 183a or 183b) includes the functionalities of session management (e.g., session establishment, modification, and release), UE IP address allocation, selection, and control of UPFs. In certain representative embodiments, the UPF 206 (e.g., which may be the same as UPF 184a or 184b) includes the functionalities of packet routing, packet forwarding, packet inspection, and traffic usage reporting.

In certain embodiments of this disclosure, integrated sensing capabilities and potential systems, methods, and devices for enhancing current 5G systems/standards are provided. For example, the enhancements may provide sensing services addressing different target verticals/applications (e.g., autonomous/assisted driving, V2X, UAVs, 3D map, smart city, smart home, factories, healthcare, maritime sector). In integrated sensing applications, there is a process of collecting sensing measurement data. The sensing measurement data, for example, may be data collected about radio/wireless signals impacted (e.g., reflected, refracted, diffracted) by an object or by an environment of interest for sensing purposes. A further example of generating sensing measurement data may be deriving sensing results from processing sensing measurement data. There may also be an area defined for sensing, e.g., a sensing service area (SSA) location, which may be an area or location (with or without at least one obstacle) in which the SSA can provide sensing service with target quality. Still further, for example, non-3GPP (N3GPP) entities are considered; sensing measurement data related to N3GPP entities may be considered as transparent to 5GS, such that the corresponding data may be communicated using a standard protocol to an interface defined by the 5GS.

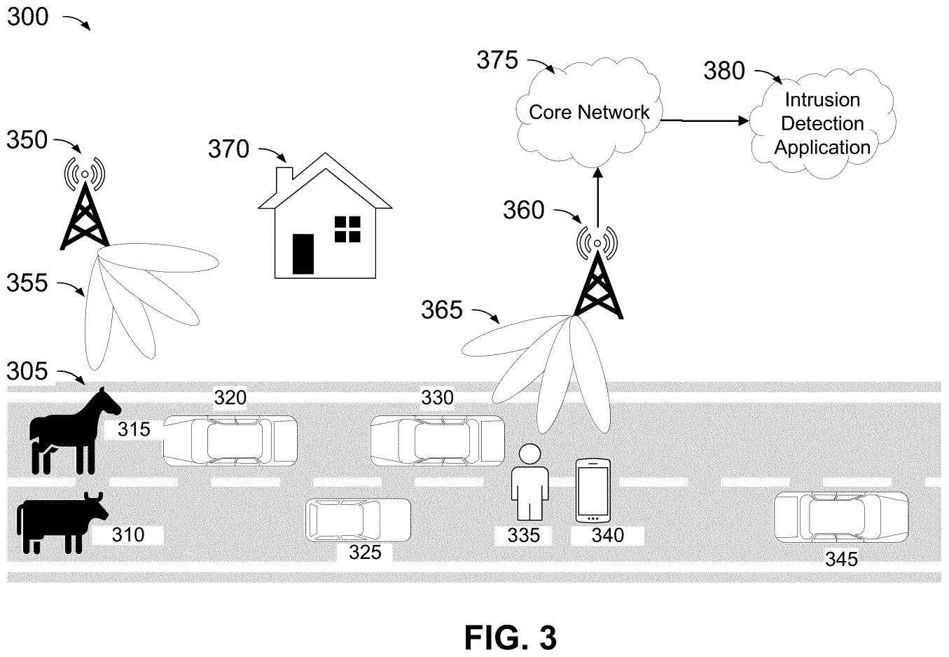

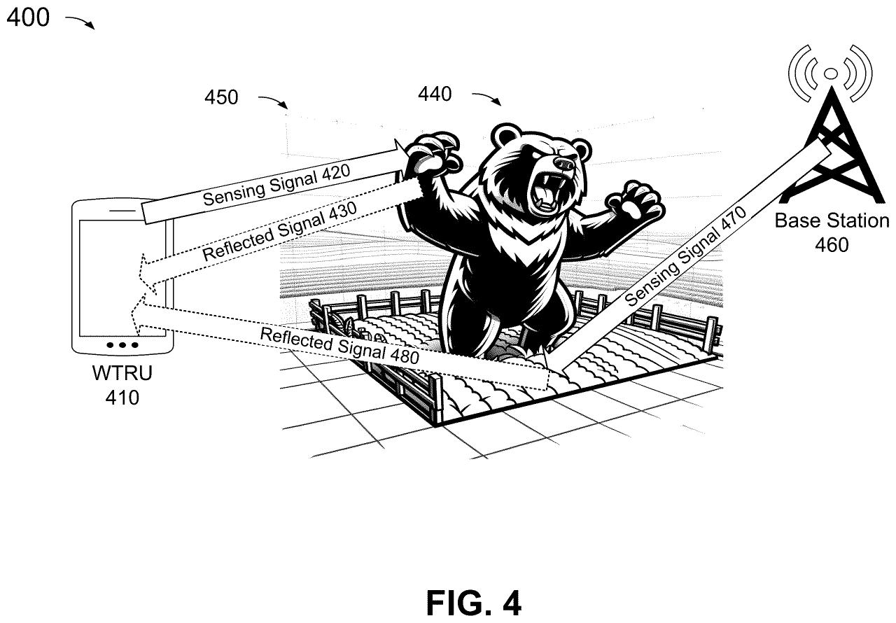

An illustrative use case for integrated sensing is object detection. For example, detection of pedestrian and/or animal intrusion detection on a highway (see, e.g., FIG. 3), or detection of an intruder in surroundings of a smart home (see, e.g., FIG. 4), are considered.

As shown in FIG. 3, for example, in an outdoor environment 300, pedestrian and/or animal intrusion detection is provided. The environment 300 includes a highway 305 and a residential property 370 adjacent the highway 305. A base station 350 (e.g., which may be the same as base station 114a or 114b) at a first location and a base station 360 at a second location emit beams 355 and 365, respectively. The beams 355 and 365 interact with the highway 305 and objects 310-345 on the highway 305 such as a first animal (e.g., cow) 310, a second animal (e.g., horse) 315, a first vehicle 320 traveling in a first direction (right-to-left on the page), a second vehicle 325 traveling in a second direction (left-to-right) opposite the first direction, a third vehicle 330 traveling in the first direction, a pedestrian 335 traveling in the first direction, the pedestrian 335 carrying a WTRU 340 (e.g., which may be the same as WTRU 102a, 102b, 102c, or 102d), and a fourth vehicle 345 traveling in the second direction. Information regarding the highway 305, the property 370, and the objects 310-345 is transmitted by the base station 360 (e.g., which may be the same as base station 114a or 114b)) to a core network 375 (e.g., which may be the same as CN 106 or 115). The core network 375 transmits the information to an intrusion detection application 380. The intrusion detection application 380 is configured to sense, identify, and/or track the objects 310-345, for example, with respect to the base stations 350, 360 and/or one or more fixed points along the highway 305 and/or the property 370. The intrusion detection application 380 may be configured to differentiate between different types of vehicles (e.g., a compact vehicle 325 versus a large vehicle 345) or different types of objects (e.g., a horse 315 versus a human 335) and corresponding locations, directions of movement, velocities, or the like.

As shown in FIG. 4, for example, in an outdoor environment 400, intruder detection in surroundings 450 of a smart home is provided. The environment 400 includes a WTRU 410 (e.g., which may be the same as WTRU 102a, 102b, 102c, 102d, or 340), an intruder (e.g., a bear) 440, and a base station 460. The WTRU 410 is configured to transmit a sensing signal 420, which, in this example, is incident on the intruder 440. The WTRU 410 is configured to receive a reflected signal 430, which, in this example, reflects the sensing signal 420 after incidence with the intruder 440. The base station 460 is configured to transmit a sensing signal 470, which, in this example, is incident on the surroundings (e.g., the ground) 450. The WTRU 410 is configured to receive a reflected signal 480, which, in this example, reflects the sensing signal 470 after incidence with the surroundings 450.

In the scenarios of FIG. 3 and FIG. 4, a base station (e.g., 350, 360, 460) and/or a WTRU (e.g., 340, 410) can detect the intrusion of an object (e.g., cow 310, vehicle 320, bear 440) into the sensing area of the base station by itself or by collaboration between the WTRU and the base station. For example, the sensing measurement is transferred to the core network 375 and further processed into the sensing result.

In certain embodiments, transparent sensing is another use case for integrated sensing wherein sensing data is captured by a WTRU and communicated so that 5GS is aware of the sensing information. The WTRU may acquire sensing measurements from different 3GPP and non-3GPP devices. 5GC may determine various available sensing services by processing collated sensing data.

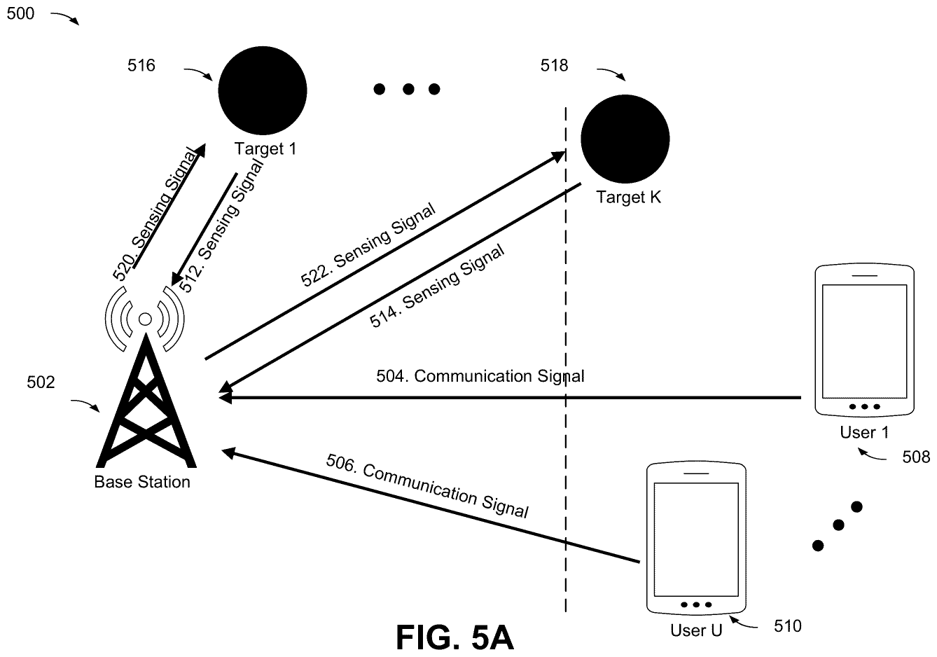

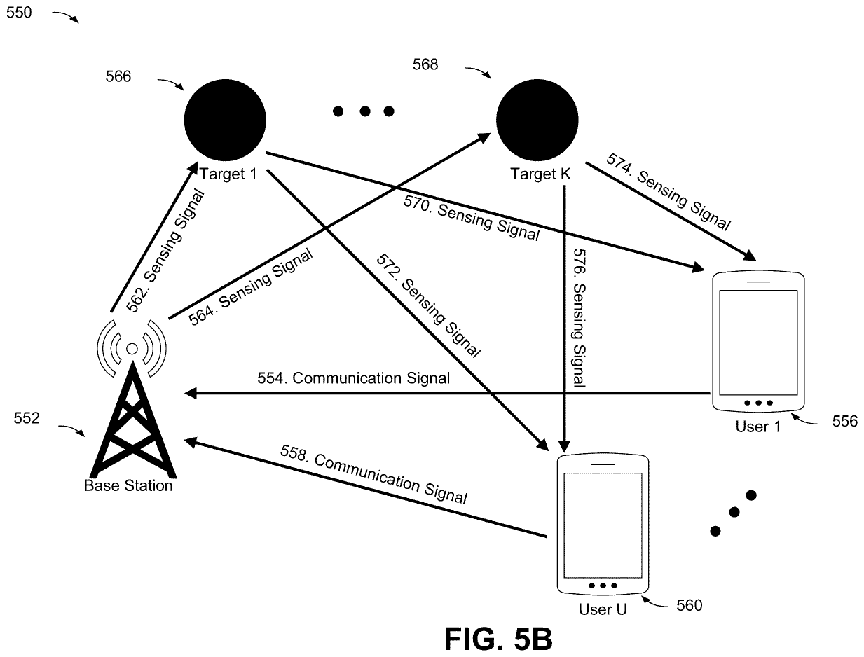

FIG. 5A illustrates an example of monostatic sensing wherein the sensing signal sender and receiver are the same node according to some embodiments of the disclosure. For example, in an environment 500, a base station 502 (e.g., which may be the same as base station 114a, 114b, 350, 360, or 460) may send a first sensing signal (e.g., sensing signal 520 or 522) and receive a second sensing signal (e.g., sensing signal 512 or 514) as a reflection of the first signal. Base station 502 may also receive communication signals 504 and/or 506 from user devices 508 and 510, respectively. The communication signals 504 and/or 506 may indicate an outcome of a sensing operation, and/or may trigger a reconfiguration (e.g., including any suitable details of the reconfiguration). As shown in FIG. 5A, “K” of “Target K” and “U” of “User U” may represent any suitable integers. It will be understood that, e.g., if U equals five, then there would be five respective user devices (although only two are shown for illustrative purposes). It will also be understood that, e.g., if K equals three, there would be three respective targets (although only two are shown for illustrative purposes).

FIG. 5B illustrates an example of bi-static sensing wherein the sensing signal sender and sensing signal receiver are two different nodes. For example, in an environment 550, a base station 552 (e.g., which may be the same as base station 114a, 114b, or 502) may receive a communication signal 554 from user device 556 and receive a communication signal 558 from user device 560. The base station 552 may also send first sensing signals 562 and 564 to targets 566 and 568, respectively. A target may reflect a first sensing signal to generate a second sensing signal (e.g., sensing signal 570 or 572) that may be recorded at a user device receiving the sensing signal. TAs shown in FIG. 5B, “K” of “Target K” and “U” of “User U” may represent any suitable integers. It will be understood that, e.g., if U equals five, then there would be five respective user devices although only two are shown. It will also be understood that, e.g., if K equals three, there would be three respective targets although only two are shown.

In certain representative embodiments, multi-static sensing is a mode of sensing that is considered and can be reconfigured in accordance with embodiments of this disclosure.

In certain representative embodiments, hierarchical sensing is conducted by multiple sensors, coordinated by a sensing network function. In certain representative embodiments, multiple sensors are directly (e.g., with the sensor knowing about at least one other sensor) or indirectly (e.g., with the sensor not knowing about other sensors) collaborating with each other (e.g., toward a distributed sensing task) by each performing their own sensing operations and correspondingly generating respective sensing information. In certain representative embodiments, multiple distributed sensors synchronously perform a joint sensing task. In certain representative embodiments, sensor fusion extends to support dynamic reconfiguration of sensor groups. As used herein, a distributed sensing task may refer to a task using distributed sensors; a fused or fusion task may refer to the use of respective data from distributed sensors to generate sensing information that is more informative than anything visible to only one of the distributed sensors. Insofar as many intelligent distributed tasks may rely on data fusion, distributed sensing and fusion may be used interchangeably in connection with embodiments of this disclosure.

In certain representative embodiments, sensor fusion may be used herein to describe the association or fusion of data from discrete sensor streams into sensing information (e.g., fused sensing information). Sensor fusion may define the coordination of sensor operations to provide synchronous sensor fusion including data from at least one WTRU and at least one other device (the at least one other device being any one or more of any one or more of a WTRU, a fuser node, a RAN node, or a base station). In certain representative embodiments, mechanisms of this disclosure provide for synchronous on-device sensor fusion. The mechanisms are provided for using sources or sensors to sense the same target object or environment, by combining (e.g., fusing) data from these sensors in such a way that sensing information is obtained from multiple sensors. For example, the entire sensing information need not be available to any single sensor, and by fusing information from multiple sensors or devices, more detailed sensing information can be obtained. In an example of complementary sensor fusion, each sensor node (e.g., a WTRU, UE, fusion device, or other device including at least one sensor and a processor coupled to the at least sensor) may sense only a partial view of the whole scene, and each sensor node senses different features. In an example of cooperative fusion, cooperative fusion combines different modes of sensing data into new information that is typically more complex than the original information. In order to consistently combine different streams of data into one fused result, sensing processes, components, and procedures may be synchronized to correctly and efficiently identify inter-related (e.g., temporal) data from different sensor streams.

In certain representative embodiments, procedures are defined for associating one or more sensor streams with synchronization (e.g., a synchronization requirement is provided by a wireless network to a WTRU, e.g., as part of a configuration or a reconfiguration). In certain representative embodiments, mechanisms are defined to provide for the synchronization of correlated information and sensing operations across multiple nodes.

In certain representative embodiments, multiple data sources and/or sensors may be used for sensing in the same environment. For example, in complementary sensor fusion, each sensor node may sense only a partial view of the whole scene, and each node contains different features. In another example, cooperative fusion combines different modes of sensing data into new information that is typically more complex than the original information.

In certain representative embodiments, once a distributed sensing task is ongoing, with a group of sensors performing distributed sensing, changes might occur, triggering the need for an update of the configuration (i.e., a reconfiguration) and/or composition of the sensing group. For example, updating the composition of the sensing group may include adding additional WTRUs or other devices to the distributing sensing task, and/or removing select WTRUs or other devices from the distributed sensing task. Some non-exhaustive examples of these triggers include mobility of the sensor(s), mobility of the object(s) being sensed, changes in the capabilities of the sensors (e.g., a LiDAR turning on/off, a camera turning on/off, or a change of operating bands in radio used for the communications), changes related to energy consumption (e.g., a sensor deciding not to continue participating in sensing or a change in the radio(s) for energy optimization), or any local policy triggered update (e.g., based on location of the sensor or time-of-day). While a distributed sensing task may benefit from dynamic reconfiguration, such dynamic reconfiguration cannot be achieved in the current 3GPP system.

In certain representative embodiments, sensing capabilities allow a WTRU (which may itself operate as a fuser node) or a fuser node (e.g., any device performing fusion tasks, which may be any suitable sensing or processing device) to sense various properties (e.g., location, velocity, or direction) of physical objects or the environment using various sensors (e.g., independently or in a collaborative manner).

In certain representative embodiments, sensor fusion overcomes limitations associated with conventional sensing mechanisms (e.g., relying on a single piece of hardware and supporting algorithms/software) such as limited coverage (i.e., each sensing node has its coverage limitations), single dimensionality/modality (i.e., a sensor may sense using only a single modality at a given time), limited confidence improvements (i.e., confidence level of a result a sensor has produced is limited to its own data), or providing a basic level of information or incomplete/limited information of the sensed object (e.g., one sensor is unable to sense all properties of an object with high confidence).

In certain representative embodiments, more complete sensing results can be achieved by combining (i.e., fusing) data from multiple sensors with varying locations and/or sensor capabilities. Combining data from multiple sensors, however, may increase synchronization complexity and requirements. In certain representative embodiments, a distributed hierarchical architecture improves the performance of distributed sensing which also supports dynamically updating the configuration of a given distributed sensing task to support mobility of sensors and/or objects.

In certain representative embodiments, a new functionality in the 5GS that assists in managing and coordinating sensing operations is denoted as the integrated sensing function (ISF). As a logical function, the ISF (e.g., ISF 190) is a collection of functionalities that may be implemented in a single function or may be implemented as separate functions. The ISF 190 may generally refer to any type of standalone logical function (e.g., which may be executed on any suitable device) that may be configured to implement the sensing functionality being performed by the CN (e.g., CN 106, 115, or 375). The functionality can be implemented in this generic ISF 190, which can be built into an existing network function or device, such as in one or more of the NEF, AMF (e.g., AMF 182a or 182b), SMF (e.g., SMF 183a or 183b), or RAN (e.g., RAN 104 or 113). For example, the ISF 190 may be collocated or executed along with a device executing any of the NEF, AMF (e.g., AMF 182a or 182b), SMF (e.g., SMF 183a or 183b) or RAN (e.g., RAN 104 or 113). In scenarios where the ISF 190 is not received directly by the 5GS, the ISF 190 may communicate with the CN (e.g., CN 106, 115, or 375) functions through the NEF and may be akin to an AF or an AS. In certain representative embodiments, the ISF 190 is capable of receiving or storing service requirements. In certain representative embodiments, the ISF 190 is capable of identifying sensing capabilities in the 5GS in WTRUs (i.e., sensing nodes) or in non-3GPP sensing capabilities that satisfy those requirements. Based on the capabilities needed, the ISF 190 may communicate with other network functions.

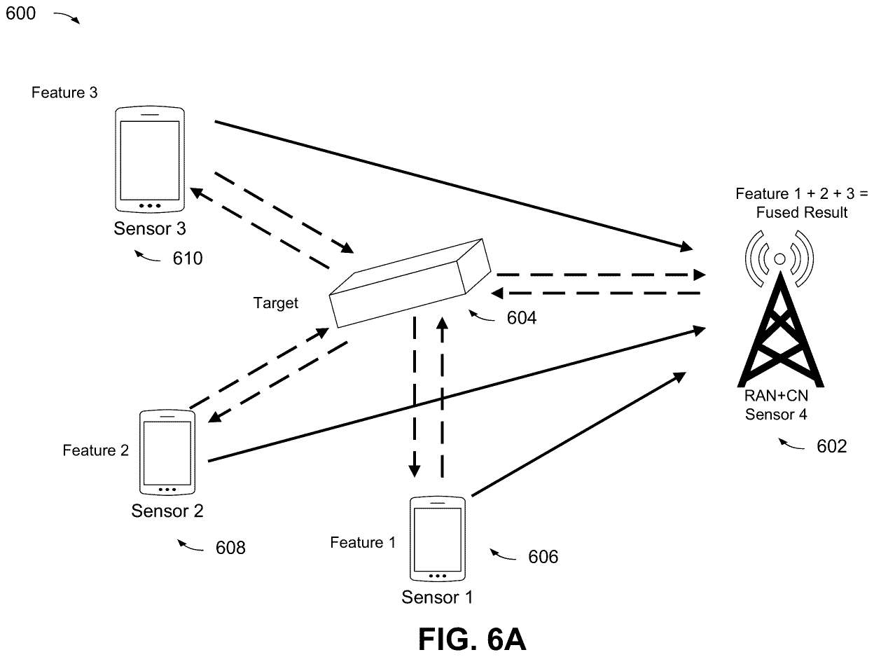

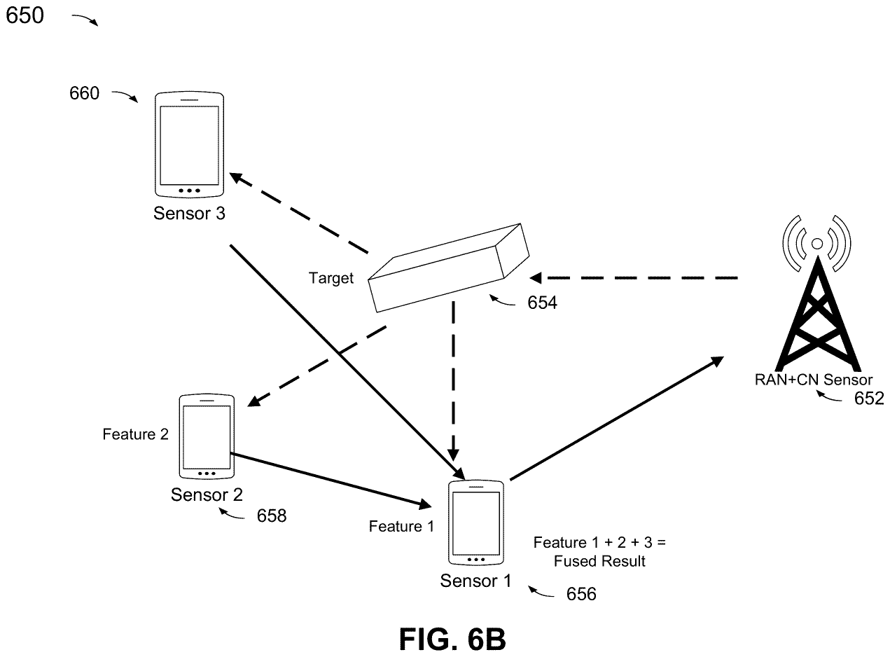

FIGS. 6A and 6B illustrate examples where multiple sensing nodes have been used for sensing a target object. Because properties such as direction, orientation, location, and sensing capabilities (e.g., sensing frequency) available at each sensor node may be different, the features (e.g., shape, distance) of the data being gathered of each the target object differs. Therefore, for gaining a complete result of the target object, data gathered from sensor nodes may be fused.

FIG. 6A illustrates an example of distributed sensing scenario where all partial sensor results, for each sensing device, are sent to the network from the respective sensor nodes and fused at the network. As shown, in environment 600, sensor node 1 606, sensor node 2 608 and sensor node 3 610 each capture different perspectives of target 604 and report corresponding data to RAN+CN sensor 4 602. The RAN+CN sensor 602 fuses the respective signals from sensor node 1 606, sensor node 2 608 and sensor node 3 610 into a fused result.

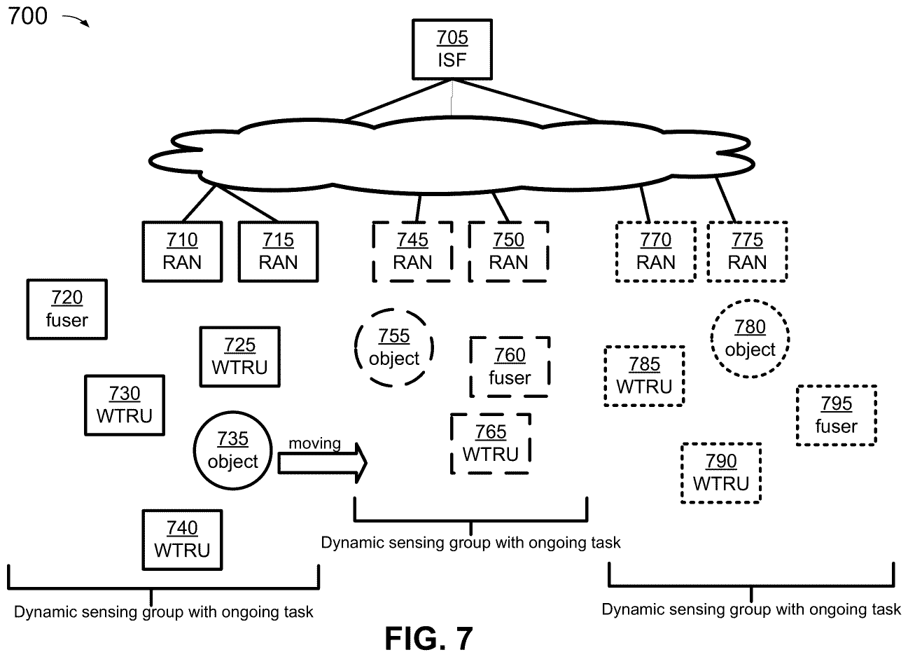

FIG. 6B illustrates an example where sensor fusion is performed at the sensor node 1 656 before sending the final fused result to the RAN+CN sensor 652. Compared to the scenario of FIG. 6A, sensor node 2 658 and sensor node 3 660 of FIG. 6B send their respective sensor results of target 654 to sensor node 1 656. Sensor node 1 656 fuses the partial results from sensor node 2 658 and sensor node 3 660 with the partial sensing results of target 654 recorded at sensor node 1 656. Sensor node 1 656 sends the fused results to RAN+CN sensor 4 652. In other embodiments, sensor node 1 656 need not be configured to perform fusion; however, to reduce the communicative power burden on sensor nodes 2 658 and sensor node 3 660, sensor node 1 656 may still receive the partial results from sensor node 2 658 and sensor node 3 660, and then send all three sets of partial results to the RAN+CN sensor 652 for data fusion and fused result generation. FIG. 7 illustrates an example of a high-level scenario with multiple active sensing groups, each group including multiple sensing devices. In environment 700, there are various sensing groups, and each these groups may coordinate (e.g., with other groups, or respective devices of the group may coordinate with each other) to perform a distributed sensing task. For example, as a target object 735 moves, sensing operations may be handed off from a first dynamic sensing group (e.g., including WTRUs 725, 730, or 740 and fuser 720) to a second dynamic sensing group (e.g., including WTRU 765 and fuser 760) that is closest to object 735 (e.g., which may be the same as any one of objects 310-345, or any other suitable object). ISF 705 (e.g., which may be the same as ISF 190) may be responsible for the reconfiguration of the sensing devices (e.g., reconfiguring WTRU 765 and fuser 760 to sense object 735 instead of WTRUs 725, 730, or 740 and fuser 720) and may also coordinate the handoffs of sensing responsibilities between respective groups. Another sensing group (e.g., comprised of WTRUs 785 or 790 and fuser 790) may perform an additional task of sensing object 780 (e.g., which may be the same as any one of objects 310-345, or any other suitable object). It is also noted that each of the WTRUs 725, 730, 740, 765, 785, or 790 may be the same as any of WTRUs 102a, 102b, 102c, 102d, 340, or 410.

In FIG. 7, a group of sensors might need to be reconfigured (e.g., in composition and/or the sensing task) due to the detection of an occurrence of an event (e.g., movement of the WTRU, movement of object 735, 755, or 780, or any other sensing target, a change in a sensing capability of the WTRU, or a policy-triggered change). In some embodiments, the event occurs at a first WTRU (e.g., any of WTRU 725, 730, or 740), and the first WTRU transmits information of the event to another device (e.g., a second WTRU 765, fuser node 760, RAN node 710 or 715, or a base station), which causes the other device to determine information related to a reconfiguration and to transmit the detection of the event and/or the reconfiguration information to a wireless network to which the WTRU is communicatively coupled. It is noted that RAN node 710 or 715 may be the same as either of RAN nodes 104 or 113.

In certain representative embodiments, the dynamic reconfiguration of sensor groups in distributed integrated sensing and communications for multi-modal sensor streams for synchronous sensor fusion is coordinated by the ISF 705 (e.g., which may more generically be referred to as a wireless network because the ISF 705 may be executed by any suitable device of the wireless network). In certain representative embodiments, the ISF 705 receives a notification of a sensor that is already part of a group of sensors executing a sensing task (e.g., within its target sensing service area) in a coordinated manner (e.g., a coordinated distributed or fusion sensor task) about a change (e.g., leaving the group, changing its sensing capabilities). In certain representative embodiments, this notification may include an estimated time before the change is effective or informs the ISF 705 without any warning time. In certain representative embodiments, this notification may include information about the updated capabilities of the sensor.

In certain representative embodiments, the ISF 705 receives a notification of a new sensor that becomes or is about to become available to participate in sensing tasks. This notification may include an estimated time before the change is effective or it just informs the ISF 705 without any warning time. In certain representative embodiments, this message may include information about the sensing capabilities of the sensor.

In certain representative embodiments, in response to receiving a notification, the ISF recomputes the best configuration of the sensing group and the distributed sensing task and informs the involved nodes (e.g., any WTRU 725, 730, 740, 765, 785, or 790, RAN 710, 715, 745, 750, 770, or 775, fuser node 720, 760, or 795, base station 114a, 114b, 350, 360, 460, 502, or 552, or any combination thereof).

In certain representative embodiments, a sensing device (e.g., WTRUs 725, 730, 740, 765, 785, or 790, RAN 710, 715, 745, 750, 770, or 775, fuser node 720, 760, or 795, base station 114a, 114b, 350, 360, 460, 502, or 552) detects and/or decides that it will change the way it operates (e.g., determines a reconfiguration and potentially causes the reconfiguration to occur) in an ongoing distributed sensing task and notifies the ISF 705 with which the device is currently in communication. This notification may include an estimated time before the change is effective or it just informs about it without any warning time. This notification may include information about the updated capabilities of the node.

In certain representative embodiments, the sensing device (e.g., WTRU 725, 730, 740, 765, 785, or 790, RAN 710, 715, 745, 750, 770, or 775, fuser node 720, 760, or 795, or base station 114a, 114b, 350, 360, 460, 502, or 552) detects a distributed sensing opportunity and/or decides to become available for distributed sensing, and notifies the ISF 705 with which it is in communication. This notification may include information about the sensing capabilities of the node.

In certain representative embodiments, the sensing device (e.g., WTRUs 725, 730, 740, 765, 785, or 790, RAN 710, 715, 745, 750, 770, or 775, fuser node 720, 760, or 795, or base station 114a, 114b, 350, 360, 460, 502, or 552) receives a reconfiguration message(s) from the ISF 705 to requesting to update the configuration of an ongoing distributed sensing task.

In certain representative embodiments, nodes that are using its local sensing capabilities for sensing are referred to as sensing nodes, sensing WTRUs (e.g., WTRUs 725, 730, 740, 765, 785, or 790) and sensing RAN nodes (e.g., RAN 710, 715, 745, 750, 770, or 775) throughout the document. These nodes may be WTRUs. These nodes may also be RAN nodes, or a combination of WTRUs and RAN nodes. In certain representative embodiments, the fuser may be a sensing device, such as a WTRU or a RAN node.

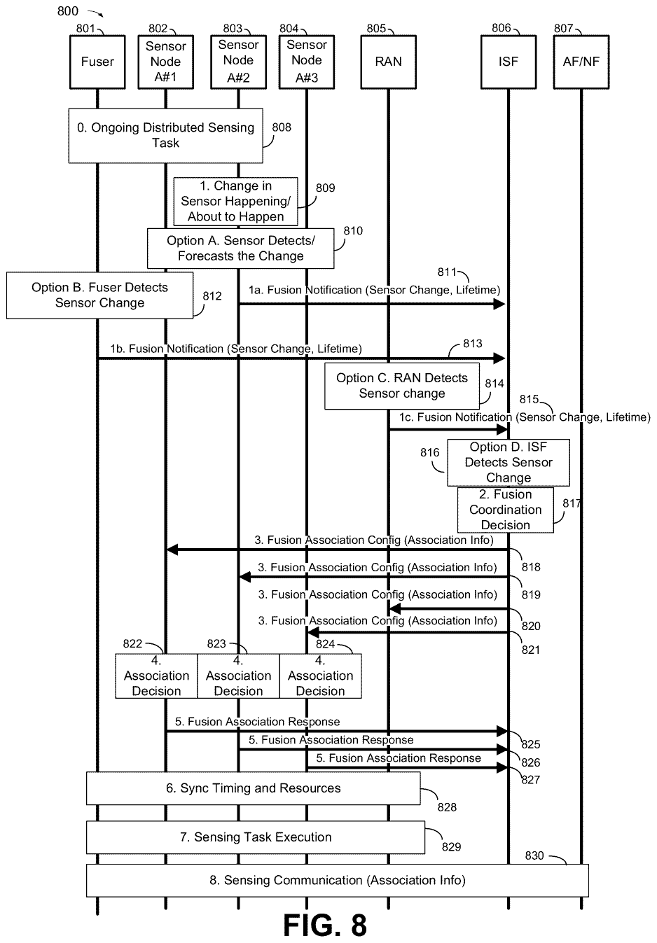

FIG. 8 illustrates an example workflow of a distributed sensing task. For the purposes of this depiction, it is assumed that all the steps to form a group and configure a distributed task have already been performed.

As shown in FIG. 8, it is assumed that there is an ongoing distributed sensing task 808. In the example of the figure, sensor nodes A #1 802 and A #2 803 are participating in the sensing task with the help of fuser node 801 (e.g., which may be the same as fuser 720, 760, or 795). In certain representative embodiments, any of sensor node A #1 802, sensor node A #2 803 or sensor node A #3 804 may be a WTRU configured for sensing a target object based on a first configuration, e.g., any of the WTRUs 102a, 102b, 102c, 102d, 340, 410, 725, 730, 740, 765, 785, or 790. The distributed sensing task may also involve the ISF 806 and/or application function (AF)/network function (NF) 807, either of both of which may be executed at a base station (e.g., base station 114a, 114b, 350, 360, 460, 502, or 552).

In step 809, there may be a change to a sensing device (e.g., sensor node A #2 803) actively participating in an ongoing sensing task. Examples of this change may include movement of a WTRU (e.g., affecting the specific type of sensor fusion that is running), mobility of the target object(s) being sensed (e.g., affecting the specific type of sensor fusion that is in place), changes in the sensing capabilities of the WTRU (e.g., a new non-3GPP sensor such as a LiDAR or camera may be turned on or off), changes in sensing capabilities from being turned off due to energy savings, changes to another sensor participating in the sensing task, or any type of policy-triggered change (e.g., location specific policies, time of day policies, or profile based policies such as a focus mode or other OS-specific mode that may be installed on corresponding devices). Any of these changes may be forecast some time before they occur or before they are detected. In certain representative embodiments, a sensing device (e.g., fuser 801, sensor node A #1 802, sensor node A #2 803, sensor node A #3 804, or RAN 805) may detect or forecast a change at step 809, and at step 811 a fusion notification may be transmitted to ISF 806 (e.g., which maybe the same as ISF 190 or 705) indicating the change. RAN 805 may be the same as any one of RAN 104, 113, 710, or 715. If a sensing device notifies the ISF 806 before the change happens, then the first information may include a predicted amount of time remaining in the sensing task (i.e., a task lifetime, which may expire at the forecasted time of the change). In certain representative embodiments, fuser 801 detects a change at step 812, and at step 813 a fusion notification is transmitted to ISF 806 indicating the change. In certain representative embodiments, RAN 805 detects a change at step 814, and at step 815 a fusion notification is transmitted to ISF 806 indicating the change. If the RAN 805 node notifies the ISF 806 before the change happens, then the fusing notification message may include a predicted remaining time in the sensing task (i.e., a task lifetime, which may expire at the forecasted time of the change). In certain representative embodiments, ISF 806 detects a change at step 816, such as a sensing device no longer being active. In a non-limiting example, this detection may occur based on not receiving any periodic notification message from the sensor.

In certain representative embodiments, a second sensor node (e.g., A #1 802) may sense the change in the first sensor node (e.g., A #2 803) and report the change to the network. In a non-limiting example, the sensing of this change may occur through a passive mode wherein a second sensor node detects that the contextual information of the first sensor node is changing. For example, the first and the second sensor may be reachable or may already be communicating over device-to-device communication. The second sensor node may detect that the conditions (e.g., distance to network/target object) has and/or will become undesirable. Then the second sensor node may send the fusion notification to the network on behalf of the first sensor node. In another non-limiting example, the sensing of this change may occur in an active mode where the first sensor node detects and/or predicts that its own contextual conditions are changing. The first sensor node decides to send a fusion notification. In this non-limiting example, instead of sending the notification directly to the network, the first sensor node sends the notification to a neighboring second sensor node (e.g., to preserve energy, or because the first node is out of a communication coverage area). The second sensor node forwards the notification received from the first sensor node to the network.

In certain representative embodiments, the change of a distributed sensing group may be dynamically triggered, e.g., if a new suitable sensor node within the target SSA becomes available outside the sensing group, and the new suitable sensor node sends its availability (e.g., to a WTRU 802, 803, or 804, RAN node 805, fuser node 801, base station 114a, 114b, 350, 360, 460, 502, or 552, or ISF 806), indicating its availability to join a sensing group. The new suitable sensor node sending its availability might also trigger the ISF 806 in the step 817 to re-evaluate whether a reconfiguration of the sensing group configuration is needed.

At step 817, the ISF 806 may reevaluate how to continue performing the sensing task using the sensors that are available. The ISF 806 may select multiple sensor nodes, including WTRUs 802, 803, or 804 or RAN node 805. In this step, one or more sensors that are not yet participating in the ongoing sensing task (e.g., A #3 804) might be selected to begin to participate in the ongoing task.

At steps 818, 819, 820 or 821, ISF 806 may reconfigure the ongoing sensing task and sends a fusion association configuration message to the RAN node 805 and to all the chosen sensor/fuser nodes for the task. In certain representative embodiments, the reconfiguration may only involve the sensor nodes that remain active through the reconfiguration, or it may also involve new sensor nodes if such nodes are available and capable to contribute to the sensing task. In certain representative embodiments, the configuration information may include or update sensor data markings. In possible scenarios where not all data sent from the sensor nodes are used for fusion, the configuration may specify how relevant data to the sensor fusion task may be marked. In certain representative embodiments, the configuration may include or update information of the sensor streams for fusion. This updated information may be specified at the WTRU, PDU session (i.e., PDU session ID), QoS flow or data stream/service data flow (SDF) levels. For example, the configuration may specify that all data coming from a first sensor and a second sensor may be fused for generating the fused result before sending it the fused result to the ISF (e.g., including but not limited to the data flows and fusion process depicted in FIG. 6B). In certain representative embodiments, the configuration information may include or update an indication if the RAN node 805 should perform sensor fusion, including the type of sensor fusion to be performed. In certain representative embodiments, the configuration information may include or update an indication if the received sensing data at the fuser are already fully or partially fused and/or if any further processing is needed. In certain representative embodiments, the configuration information may include or update, an indication if sensor fusion is performed by a nearby node and the information of the sensor fuser. In certain representative embodiments, the configuration information may include or update synchronization requirements. In a non-limiting example, synchronization requirements may specify the required precision of timing data in the sensor data.

At steps 822, 823, or 824, the sensor node may decide whether to be associated with the sensor/fusion task. For example, a sensor node need not decide to associate itself with the new sensing task request, even if agreeing at the discovery and group association stages, if the node is already involved in a sensing or fusion task.

At steps 825, 826, or 827, the sensor node may respond to the ISF 806 with its decision to accept or reject the sensing/fusion task. If rejected, the sensor may specify the reason for rejection. In turn, the ISF 806 may store the received availability information of the sensor node.

At step 828, synchronization procedures may be performed or updated.

At step 829, the configured sensing entities may perform the sensing task.

At step 830, the sensor node may communicate sensor/fusion data with the ISF 806, AF 807 or any other NF. This data may include the association information (e.g., markings in data which specify the group of data a single data chunk belongs to).

In certain representative embodiments, steps similar to those shown in FIG. 8 may be performed (e.g., by a wireless network, or by a first sensing node in communication with the wireless network) to support the integration of a new sensing node into the ongoing sensing task. For example, the reconfiguration may include adding at least one new sensing node. Accordingly, the new sensing node, the sensing node that was already participating in the task, or both, may be reconfigured in connection with embodiments of this disclosure.

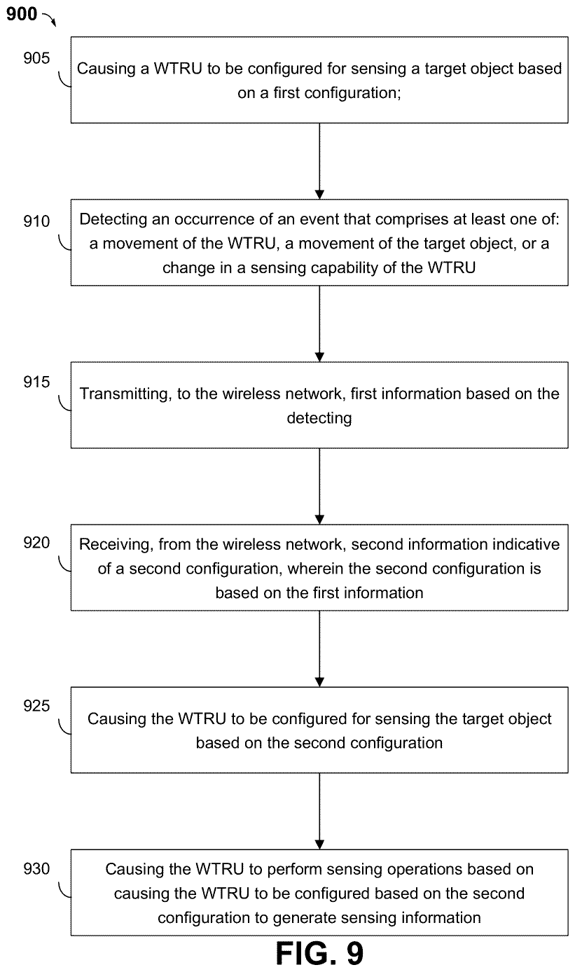

FIG. 9 illustrates an example of a method 900 for the dynamic reconfiguration of sensor groups in distributed integrated sensing and communication task. The method 900 may be performed by a WTRU, such as a WTRU 102 of FIGS. 1A-D, WTRU 340 of FIG. 3, WTRU 410 of FIG. 4, WTRU 725, 730, 740, 765, 785, or 790 of FIG. 7, or a WTRU 802, 803, or 804 in FIG. 8. The method 900 may also be performed by any of the sensor nodes of FIGS. 6A-6B. Method 900 includes causing, at step 905, a WTRU to be configured for sensing a target object (e.g., which may be any one of objects 310-345, 735, 755, or 780) based on a first configuration. In certain representative embodiments, the causing at step 905 may correspond to step 0 of FIG. 8. Method 900 includes detecting, at step 910, an occurrence of an event that comprises at least one of: a movement of the WTRU, a movement of the target object, or a change in a sensing capability of the WTRU. In certain representative embodiments, the detecting at step 910 may correspond to step 1 of FIG. 8. Method 900 includes transmitting at step 915, to the wireless network, first information based on the detecting. In certain representative embodiments, the transmitting 915 may correspond to step 1b and step 1c of FIG. 8. The method 900 includes receiving, at step 920, from the wireless network, second information indicative of a second configuration, where the second configuration is based on the first information. In certain representative embodiments, the receiving at step 920 may correspond to steps 2 and 3 of FIG. 8. Method 900 includes causing, at step 925, the WTRU to be configured for sensing the target object based on the second configuration. In certain representative embodiments, the causing at step 925 may correspond to steps 4-6 of FIG. 8. Method 900 includes causing, at step 930, the WTRU to perform sensing operations based on causing the WTRU to be configured based on the second configuration to generate sensing information. In certain representative embodiments, the causing at step 930 may correspond to steps 7-8 of FIG. 8.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke means-plus-function claim format, and any claim without the terms “means for” is not so intended.

What is claimed is:

1. A method performed by a wireless transmit/receive unit (WTRU) in communication with a wireless network, the method comprising:
causing the WTRU to be configured for sensing a target object based on a first configuration;
detecting an occurrence of an event that comprises at least one of: a movement of the WTRU, a movement of the target object, or a change in a sensing capability of the WTRU;
transmitting, to the wireless network, first information based on the detecting;
receiving, from the wireless network, second information indicative of a second configuration, wherein the second configuration is based on the first information;
causing the WTRU to be configured for sensing the target object based on the second configuration; and
causing the WTRU to perform sensing operations by causing the WTRU to be configured based on the second configuration to generate sensing information.

2. The method of claim 1, wherein:
the detecting of the occurrence of the event comprises forecasting that the event will occur; and
the first information comprises an indication of when the forecasted event will occur.

3. The method of claim 1, wherein the first configuration is based on a distributed sensing task involving the WTRU and at least one other device.

4. The method of claim 3, wherein the at least one other device comprises any one or more of:
a WTRU, a fuser node, a radio access network (RAN) node, or a base station.

5. The method of claim 3, wherein transmitting the first information comprises:
the transmitting of the first information to the at least one other device; and
causing the at least one other device to transmit the first information to the wireless network.

6. The method of claim 3, wherein the detecting of the occurrence of the event comprises detecting a change in contextual information associated with the at least one other device, wherein the contextual information associated with the at least one other device comprises: a movement of the at least one other device or a change in a sensing capability of the at least one other device.

7. The method of claim 1, wherein the first information further comprises a policy-triggered change based on at least one of: a location, a time of day, or a sensing profile associated with the sensing of the target object based on the first configuration.

8. The method of claim 1, wherein the second information comprises a fusion association configuration comprising at least one of: sensor data markings, fusion information related to the sensing of the target object, a type of sensor fusion to be performed, an indication of processing needed to process the sensing information, a node of the wireless network that performs sensor fusion, or a synchronization requirement.

9. The method of claim 1, wherein the sensing information comprises association information related to the sensing operations and based on the second configuration.

10. The method of claim 1, wherein at least one of the first information or the second information comprises updated capabilities related to the sensing operations.

11. A wireless transmit/receive unit (WTRU) that is in communication with a wireless network, the WTRU comprising a processor and a transceiver configured to:
cause the WTRU to be configured for sensing a target object based on a first configuration;
detect an occurrence of an event that comprises at least one of: a movement of the WTRU, a movement of the target object, or a change in a sensing capability of the WTRU;
transmit, to the wireless network, first information based on the detecting;
receive, from the wireless network, second information indicative of a second configuration, wherein the second configuration is based on the first information;
cause the WTRU to be configured for sensing the target object based on the second configuration; and
cause the WTRU to perform sensing operations by causing the WTRU to be configured based on the second configuration to generate sensing information.

12. The WTRU of claim 11, wherein the processor and the transceiver are further configured to:
when detecting the occurrence of the event, forecast that the event will occur, wherein the first information comprises an indication of when the forecasted event will occur.

13. The WTRU of claim 11, wherein the first configuration is based on a distributed sensing task comprising the WTRU and at least one other device, and the at least one other device comprises any one or more of: a WTRU, a fuser node, a radio access network (RAN) node, or a base station.

14. The WTRU of claim 13, wherein, when transmitting the first information, the processor and the transceiver are further configured to:
transmit the first information to the at least one other device, and
cause the at least one other device to transmit the first information to the wireless network.

15. The WTRU of claim 13, wherein the processor and the transceiver are further configured to detect the occurrence of the event by detecting a change in contextual information associated with the at least one other device, wherein the contextual information associated with the at least one other device comprises: a movement of the at least one other device or a change in a sensing capability of the at least one other device.

16. The WTRU of claim 11, wherein the first information further comprises a policy-triggered change based on at least one of: a location, a time of day, or a sensing profile associated with the sensing of the target object based on the first configuration.

17. The WTRU of claim 11, wherein the second information comprises a fusion association configuration comprising at least one of: sensor data markings, fusion information related to the sensing of the target object, a type of sensor fusion to be performed, an indication of processing needed to process the sensing information, a node of the wireless network that performs sensor fusion, or a synchronization requirement.

18. The WTRU of claim 11, wherein the processor and the transceiver are further configured to generate the sensing information by generating association information related to the sensing operations and based on the second configuration.

19. The WTRU of claim 11, wherein at least one of the first information or the second information comprises updated capabilities related to the sensing operations.

20. A method performed by a wireless network in communication with a wireless transmit/receive unit (WTRU), the method comprising:
causing the WTRU to be configured for sensing a target object based on a first configuration;
receiving, from the WTRU, first information, wherein the first information is based on a detection of an event that comprises at least one of: a movement of the WTRU, a movement of the target object, or a change in a sensing capability of the WTRU; and
transmitting, to the WTRU, second information indicative of a second configuration, wherein the second configuration is based on the first information, and the second configuration is used by the WTRU to configure the WTRU for sensing the target object.
